(19) United States
(12) Patent Application Publication
(10) Pub. No.: US 2026/0050370 A1
(43) Pub. Date: Feb. 19, 2026

(54) CONTEXT-AWARE CONTENT DRAG/DROP IN LIVE ONLINE MEETINGS

(71) Applicant: Cisco Technology, Inc., San Jose, CA (US)

(72) Inventors: Rajarshee Dhar, Cary, NC (US); Rammohan Ravindranath, Bangalore (IN); Deepesh Arora, Punjab (IN)

(21) Appl. No.: 18/800,371

(22) Filed: Aug. 12, 2024

(51) Int. Cl. G06F 3/0486; G06F 3/14; H04L 12/18

(52) U.S. Cl. CPC G06F 3/0486; G06F 3/1454; H04L 12/1813

(57) ABSTRACT

Techniques are provided for enhanced content sharing in a collaboration session using intuitive drag-and-drop actions. A method includes a first collaboration application client associated with a first device initiating a collaboration session with a second collaboration application client associated with a second device and detecting a drag-and-drop action performed on the first device for dragging a content from a first local application on the first device and dropping the content into the collaboration session. The method further includes the first collaboration application client transmitting the content from the first collaboration application client to the second collaboration application client to cause the second collaboration application client to display the content at a particular location within a second local application running on the second device.

### TECHNICAL FIELD

The present disclosure relates to content sharing in collaboration sessions.

### BACKGROUND

Virtual meeting software applications enable users to communicate and collaborate from remote locations, offering features such as audio-video conferencing, screen sharing, instant messaging (IM), document co-editing, remote desktop control, live polling, etc. In a collaboration session, a user can share a screen, window, or application with other meeting participants. Moreover, the user can invite the participants to annotate the shared screen or collaborate in a “whiteboard” session in which each participant can annotate and co-edit a document. While these features are helpful in facilitating a collaborative meeting environment, users often find it difficult to share application-specific content with other participants in an intuitive manner.

For example, if a first user wishes to add a specific content (e.g., software code, presentation slide, image, etc.) to a second user's application shared via the screen-sharing feature, the first user must send the specific content as a file to the second user through an interface, such as the IM interface of the virtual meeting software application. In addition to sending the content, the first user (sender) needs to direct the second user (recipient) to the exact location where the first user wishes to see the content inserted/added in the second user's application. The need for file exchanges and verbal/textual communication creates barriers to effective collaboration.

### BRIEF DESCRIPTION OF THE DRAWINGS

FIG. 1 is a block diagram illustrating a system configured to provide a collaboration session among a plurality of users and to enable drag-and-drop content sharing features, according to an example embodiment.

FIG. 2A is a diagram illustrating a collaboration session from a view of a first device associated with a first user participating in the collaboration session with a second user, according to an example embodiment.

FIG. 2B is a diagram illustrating a collaboration session in which a first user drags a content from a first local application and drops the content into the collaboration session, according to an example embodiment.

FIG. 2C is a diagram illustrating a collaboration session in which a content dropped into a shared screen is transmitted to a second local application on a second device associated with a second user, according to an example embodiment.

FIG. 3A is a diagram illustrating a collaboration session in which a second user shares a second local application with a first user, and for which the techniques presented herein may be employed, according to an example embodiment.

FIG. 3B is a diagram illustrating a drag-and-drop action performed by a first user, according to an example embodiment.

FIG. 3C is a diagram illustrating a drop of a content in a specific location on a second local application, according to an example embodiment.

FIG. 3D is a sequence diagram illustrating a process for sharing content in a collaboration session between a first local application of a first device and a second local application of a second device, according to an example embodiment.

FIG. 4 is a diagram illustrating a remote desktop control session in which a first user drags a content from a first local application and drops the content into a second local application.

FIG. 5 is a flow chart illustrating a method for transmitting a content from a first collaboration application client to a second collaboration application client to cause the second collaboration application client to display the content at a particular location within a second local application, according to an example embodiment.

FIG. 6 is a flow diagram illustrating a method for displaying a content on a particular location within a second local application, according to an example embodiment.

FIG. 7 is a hardware block diagram of a computing device configured to perform one or more techniques presented herein.

### DETAILED DESCRIPTION

### Overview

Techniques are provided for enhanced content sharing in a collaboration session. In one embodiment, a method includes a first collaboration application client associated with a first device initiating a collaboration session with a second collaboration application client associated with a second device and detecting a drag-and-drop action performed on the first device for dragging a content from a first local application on the first device and dropping the content into the collaboration session. The method further includes the first collaboration application client transmitting the content from the first collaboration application client to the second collaboration application client to cause the second collaboration application client to display the content at a particular location within a second local application running on the second device.

In another embodiment, a method includes a second collaboration application client on a second device receiving a content from a first collaboration application client on a first device in a collaboration session established by a collaboration server, the content being associated with a drag-and-drop action made on the first device for dragging the content from a first local application on the first device and dropping the content into the collaboration session. The method further includes the second collaboration application client determining a particular location within a second local application on the second device based on the content and displaying the content on the particular location within the second local application.

### Example Embodiments

Techniques are presented herein to provide content sharing between at least two users in a collaboration session. A first user and a second user establish connection in a collaboration session where the second user shares a screen or window displaying a second local application. The first user transfers a content from a first local application to the second local application by dragging the content from the first local application and dropping the content into a specific location of the second local application being displayed in the shared screen. Upon the completion of the drag-and-drop action by the first user, the second user can view the content displayed at the specific location of the second local application. Thus, the techniques presented herein allow a user to seamlessly and precisely place a desired content into a specific location on another user's local application, thus reducing the need for repeated file exchanges and providing an intuitive content sharing experience.

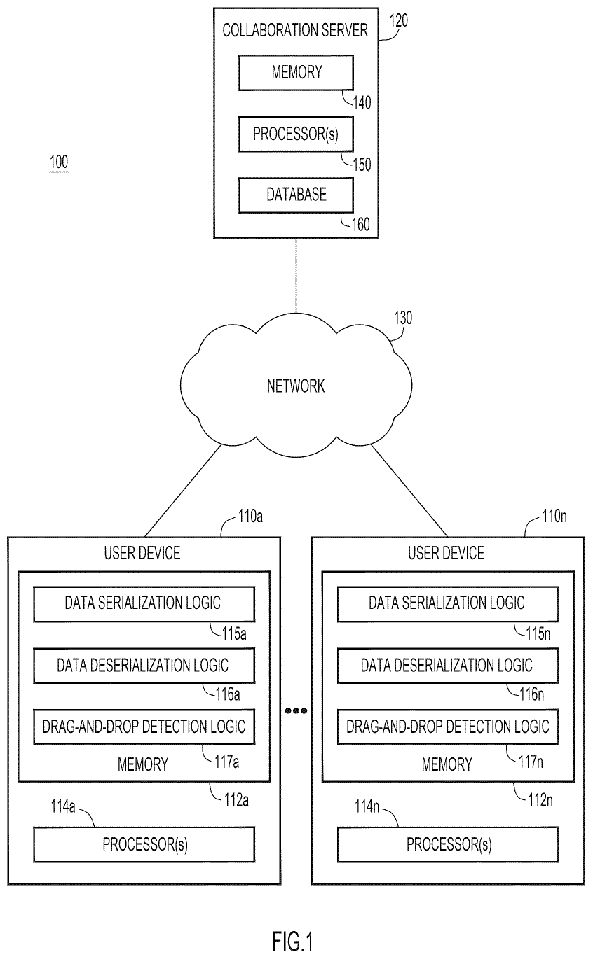

Reference is first made to FIG. 1, for a description of a block diagram illustrating a system 100 for providing a collaboration session, according to an example embodiment. The system 100 includes a plurality of user devices (devices) 110a-110n, a collaboration servers 120, and a network (or a collection of networks) 130. The notation “a-n” denotes that a number is not limited, can vary widely, and depends on a particular use case scenario.

In the system 100, one or more users may be participating in a collaboration session using their respective user devices 110a-n. The collaboration session is managed and/or controlled by the collaboration server 120. The devices 110a-110n communicate with the collaboration server 120 via the network 130. It should be understood that there may be multiple collaboration servers in a given system deployment to enable load balancing the serving of multiple collaboration sessions.

Each of the devices 110a-110n respectively includes a memory 112a-112n, respectively, and one or more processors 114a-114n, respectively. The one or more processors 114a-114n are configured to perform one or more operations of the devices 110a-110n, respectively. The memory 112a-112n includes instructions for various software programs/modules to be executed by the processor(s) 114a-114n, respectively, to carry out certain aspects of the techniques presented herein. For example, the memory 112a-112n includes instructions for a data serialization logic 115a-115n, respectively, a data deserialization logic 116a-116n, respectively, and a drag-and-drop detection logic 117a-117n, respectively. The data serialization logic 115a-114n enables a collaboration application client to generate a serialized data structure using suitable encryption methods for representing a content. The data deserialization logic 116a-116n enables the collaboration application client to reconstruct a serialized data structure. The drag-and-drop detection logic 117a-117n enables the collaboration application client to identify a drag-and-drop action performed on each of the respective devices 110a-110n. Further aspects associated with the operations enabled by the data serialization logic 115a-115n, data deserialization 116a-116n and drag-and-drop detection logic 117a-117n will be described below.

The collaboration server 120 includes a memory 140, one or more processors 150, and a database 160. The one or more processors 150 are configured to perform one or more operations of the collaboration server 120. The database 160 is configured to store one or more content items, metadata, or data associated with one or more collaboration sessions established by the collaboration server 120. The memory 140 includes instructions for various software programs/modules to be executed by the one or more processor(s) 150 to carry out certain aspects of the techniques presented herein.

The network 130 may include a local area network (LAN), a wide area network (WAN) such as the Internet, or a combination thereof, and includes wired, wireless, or fiber optic connections. In general, the network 130 can use any combination of connections and protocols that support communications between the entities of the system 100. The user devices 110a-n may obtain a session identifier and/or an identifier of content, such as a document, corresponding to the session by communicating with the collaboration server 120.

In one example embodiment, the user devices 110a-n communicate with the collaboration server 120 and the collaboration server 120 retrieves and distributes content to the user devices 110a-n. In various example embodiments, the collaboration server 120 controls a shared screen to which multiple users may have access throughout the collaboration session.

According to yet another example embodiment, there may be no centralized deciding entity, such as an arbitration server, that decides which user in a collaboration session is active at any given time. Instead, every device makes its own decision as to which other device is an active user at any given point in time. That is, the collaboration session may operate in a peer-to-peer (P2P) manner where each device broadcasts information to other devices and each device makes independent decisions based on the received information. The device broadcasts pass through the collaboration server 120 that distributes it to other devices in the collaboration session and applies it to the content, which may be displayed on a user interface associated with the collaboration session.

The collaboration server 120 is configured to communicate with various collaboration application clients executing on the user devices 110a-n. The collaboration application clients running on the user devices 110a-n detect various actions performed by the respective users during a collaboration session and notify the respective collaboration server associated with the collaboration session about these events. The collaboration server 120 may render or display on a user interface screen of the respective device one or more content of the collaboration session. That is, the collaboration server 120 sends commands to the collaboration application clients running on the user devices 110a-n to render content in a particular way, to change views, controls, and so on. The collaboration application clients can be a web application accessible on a website or an application installed on the user device (e.g., mobile or desktop application).

Collaboration sessions established by collaboration server 120 offer a screen-sharing functionality that allows users to share content, such as a presentation, with other users participating in the meeting. In screen-sharing mode, the collaboration server 120 receives notification of a detected event indicating an intent to share screen (e.g., user clicking a “share” button) from collaboration application clients running on the user devices 110a-n. In response, the respective collaboration server may render or display on a user interface screen of the respective device one or more content of the collaboration session. For example, upon detecting a first collaboration application client has selected a window/screen to share with a second collaboration application client, the collaboration server 120 renders the user interface screen associated with the second collaboration application client to display the window/screen shared by the first collaboration application client.

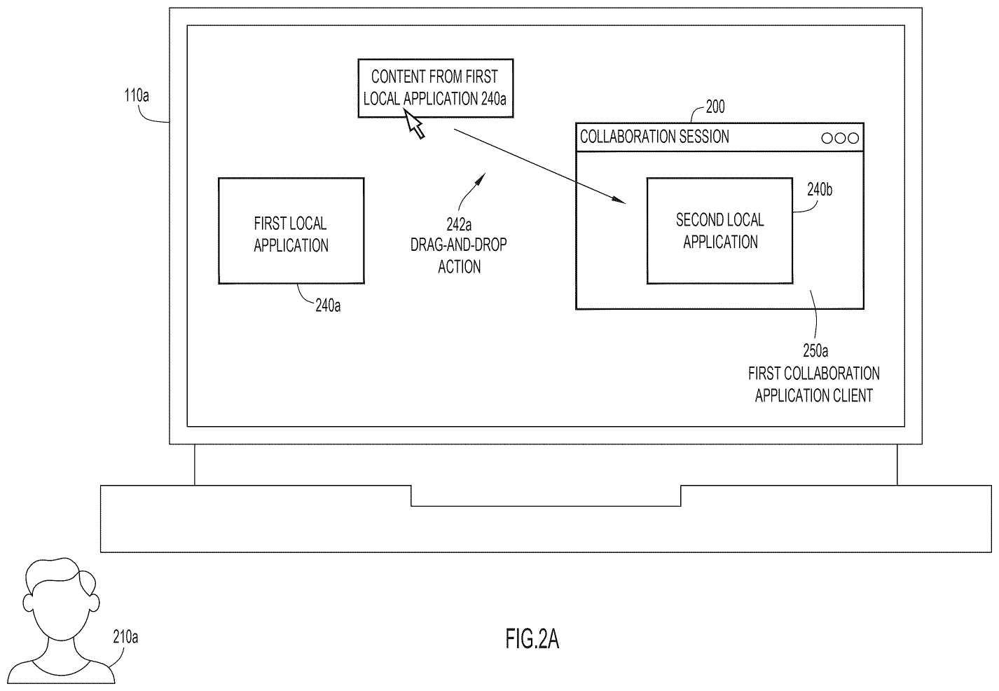

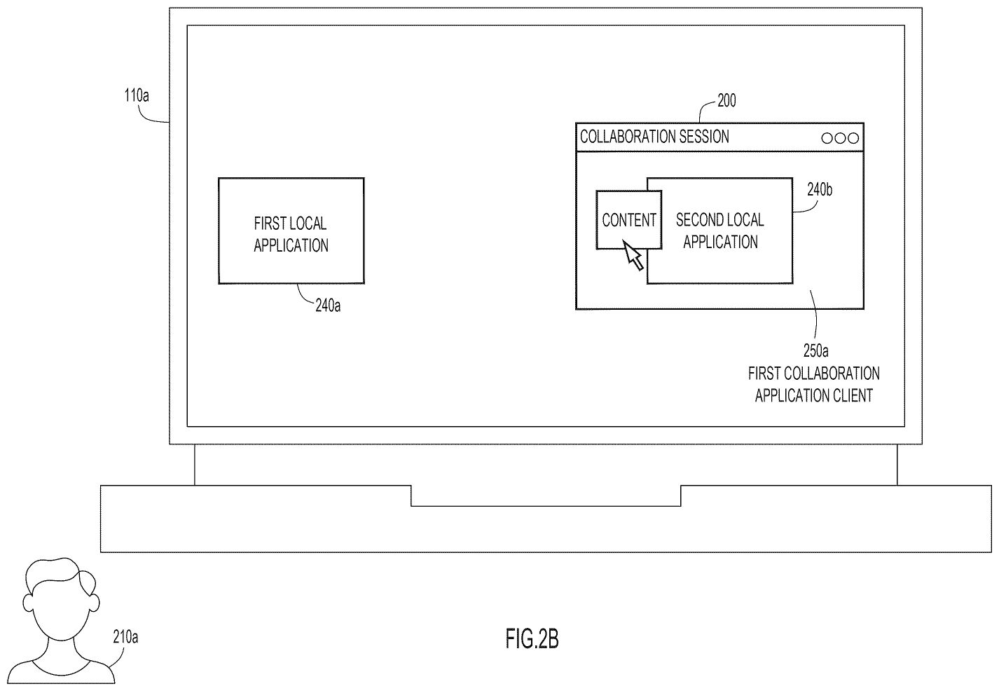

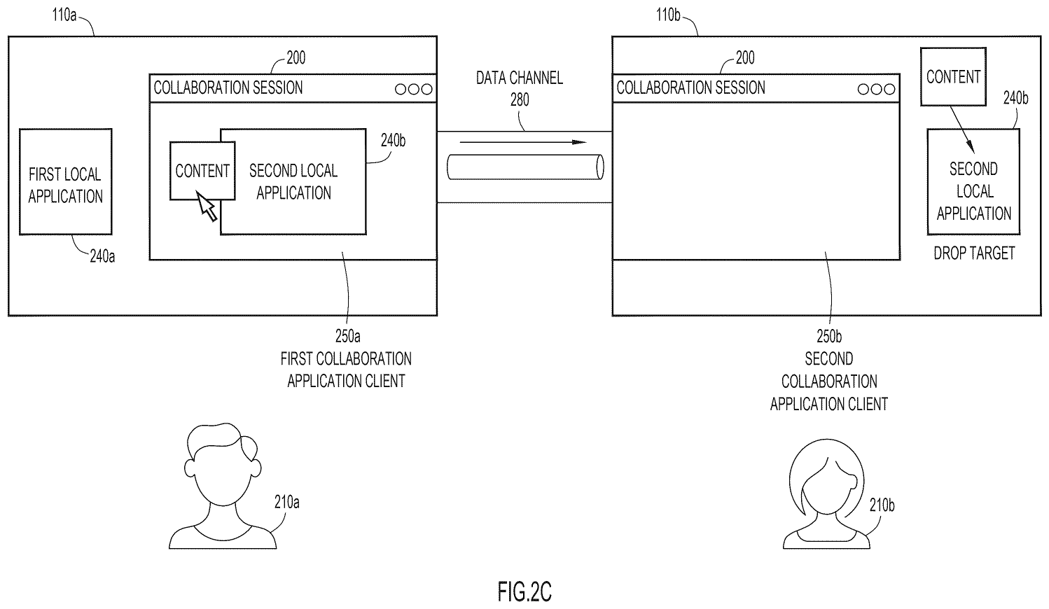

Turning now to FIG. 2A, a diagram illustrating a collaboration session from a view of a first device associated with a first user participating in the collaboration session with a second user is described. The collaboration server 120 connects a first user 210a and a second user to a collaboration session 200 via their respective user devices shown in FIG. 1.

In the collaboration session 200, a second user shares a second local application 240b on a second device with the first user 210a using a screen-sharing functionality. The collaboration server renders a display of the second local application 240b on a user interface of a first collaboration application client 250a associated with the first user 210a. The first user 210a of a first device 110a drags a content from a first local application 240a and drops the content into the collaboration session 200 displaying the second local application 240b.

During the collaboration session 200, one or more drag-and-drop actions 242a-n are performed by a first user 210a. The one or more drag-and-drop actions 242a-n involve the first user 210a dragging a content from the first local application 240a of the first device 110a associated with the first user 210a and dropping the content into the shared screen displayed on the user interface of the first collaboration application client 250a. For example, the second user shares a slideshow presentation application with the first user 210a. The collaboration server renders a display of the slideshow presentation application on the user interface of the first collaboration application client 250a associated with the first user 210a. The first user 210a, intending to add a slide to the slideshow presentation application shared by the second user, drags the slide from the first local application 240a and drops it into the shared screen displayed on the first collaboration application client 250a.

The first collaboration application client 250a, upon detecting a drag-and-drop action 242a from the first user 210a, transmits a message to a second collaboration application client associated with the second user to request permission to drop the content into the shared screen displayed in the collaboration session 200. The first collaboration application client 250a drops the content into the shared screen once permission is granted by a second collaboration application client.

In certain embodiments, the first collaboration application client 250a detects the drag-and-drop action 242a using an application programming interface (API) configured to register drag-and-drop actions. For example, the API registers the first collaboration application client 250a as the drop target when the first user 210a drags a content from the first local application 240a (drag source) and drops the content to the first collaboration application client 250a. Further, the API registers the second collaboration application client as the drag source and the second local application 240b as the drop target for another drag-and-drop action associated with the second device.

The type of API used to register drag-and-drop actions 242a-n depends on an operating system of a user device. For example, for user devices using Windows®, the Win32® API can be used to register drag-and-drop actions through the RegisterDragDrop function (ole2.h). Other functions may be used, including the UIElement. Drop Event in the Windows Runtime API and drag-and-drop operations in APIs associated with the .NET framework. For user devices using macOS®, the “Drag and Drop”API from AppKit can be used.

Upon detecting a drag-and-drop action 242a from the first user 210a, the first collaboration application client 250a determines one or more first coordinates representing a cursor position of a drop location associated with the drag-and-drop action 242a. Further, the first collaboration application client 250a determines an identity of the first local application 240a from which the content is being dragged. For example, upon detecting the drag-and-drop action 242a by the first user 210a, the first collaboration application client 250a determines the first user 210a has dragged application-specific content (e.g., a slide) from the first local application 240a (e.g., a slideshow presentation application) and captures the one or more first coordinates representing the cursor position of the drop location.

Moreover, the first collaboration application client 250a can determine additional information associated with the drag-and-drop action 242a, including one or more of a content type of the content, information associated with a device operating system, a window resolution, an aspect ratio, or a data object. For example, the first collaboration application client 250a captures the operating system name, window resolution, and aspect ratio of the first device 110a upon detecting the drag-and-drop action 242a from the first user 210a. Further, the first collaboration application client 250a determines one or more drop point coordinates relativity values.

The first collaboration application client 250a generates a serialized data structure to represent the content dropped into the shared screen using the information associated with the drag-and-drop action 242a. The serialized data structure is generated using end-to-end encryption such that only an intended recipient (e.g., second collaboration application client) can decrypt the serialized data structure. The serialization of the data structure can be implemented using a data serialization API employing suitable data encryption techniques. The format of the serialized data structure may depend on the operating system of the user device. By way of example, a serialized data structure representing a content dragged from the first local application 240a and dropped into the shared screen includes the following data and/or metadata:
DragDropContent {
content: <blob>,
sourceApp: PowerPoint,
DropPointCoordinates =[x, y],
Resolution: 640×480,
AspectRatio: 1:3
OSInfo: Windows 11
ApplicationSpecificContent: { . . .
DataObject: {
. . .
. . . }, }, }
   For example, in Windows®, the “DataObject” can be generated by invoking the IDataObject function using the Win32® API.

Once the first collaboration application client 250a generates the serialized data structure representing the content and receives permission to drop the content from the second collaboration application client, the first collaboration application client 250a transmits a message and the serialized data structure to the second collaboration application client through a data channel between the first collaboration application client 250a and the second collaboration application client.

Turning now to FIG. 2B, a diagram illustrating the collaboration session 200 in which the first user 210a drags a content from the first local application 240a and drops the content into the collaboration session 200 is described. FIG. 2B illustrates another view of the first device 110a associated with the first user 210a after the first user 210a successfully drags and drops the content into the shared screen in the collaboration session 200 displaying the second local application 240b.

In certain embodiments, the first local application 240a from which the content is dragged and the second local application 240b displayed in the shared screen are the same type of application. For example, both the first local application 240a and second local application 240b can be a slideshow presentation application, a word processing application, a code editing application, a web browser, or any suitable software applications where content can be dragged and dropped. In other embodiments, the first local application 240a and second local application 240b are different types of application. For example, the first local application 240a is a word processing application while the second local application 240b is a slideshow presentation application. The content can be text, image, presentation slide, software code snippets, video, tabs or bookmarks from web browsers, subtitle files, file directories, electronic contact cards, or any other suitable data objects.

FIG. 2C is a diagram illustrating the collaboration session 200 in which the content dropped into a shared screen is transmitted to the second local application 240b on a second device 110b associated with a second user 210b. Continuing from FIG. 2B, the first collaboration application client 250a transmits the message and the serialized data structure to a second collaboration application client 250b through a data channel 280 between the first collaboration application client 250a and the second collaboration application client 250b.

When the second collaboration application client 250b receives the message and the serialized data structure from the first collaboration application client 250a, the second collaboration application client 250b deserializes the serialized data structure to reconstruct an original data structure representing the content. Deserialization can be implemented using any suitable technique. The reconstructed data structure comprises one or more of the following: a content type, a local application identity, one or more first coordinates, information associated with a device operating system, a window resolution, an aspect ratio, or a data object. For example, when the content is associated with a drag-and-drop action performed by the first user 210a, the reconstructed data structure stores information of the identity of the first local application 240a, the one or more first coordinates representing the drop location, as well as the device operating system, window resolution, and aspect ratio of the first device 110a.

After generating the reconstructed data structure, the second collaboration application client 250b determines one or more second coordinates representing a particular location on the second local application 240b that correspond to one or more first coordinates representing the drop location. The second collaboration application client 250b, using the window resolution of the first device 110a, translates the one or more first coordinates representing the drop location to one or more local coordinates on the screen of the second device 110b that is being shared by the second collaboration application client 250b. Then, the second collaboration application client 250b determines that a window of the second local application 240b covers the one or more local coordinates, which correspond to the one or more second coordinates on the second local application 240b where the content will be displayed.

The translation of the one or more first coordinates representing the drop location to the one or more second coordinates on the second local application 240b is implemented based on one or more drop point coordinates relativity values. The one or more drop point coordinates relativity values are determined based on a relativity between the one or more first coordinates representing the drop location and one or more coordinates representing a screen being shared by the second collaboration application client 250b. Further aspects associated with the translation will be described below.

In some embodiments, a first window size of the first collaboration application client 250a running on the first device 110a and a second window size of the second collaboration application client 250b running on the second device 110b are different. In such embodiments, the second collaboration application client 250b determines a difference between the first window size and the second window size. Then, the second collaboration application client 250b determines the one or more second coordinates based on the one or more first coordinates and the difference in window size. Further, a first window resolution of the first device 110a is compared to a second window resolution of the second device 110b to generate a difference in window resolution, which can be used to determine the one or more second coordinates.

In some embodiments, the window size of the first local application 240a and the window size of the second local application 240b are different. In such embodiments, the second collaboration application client 250b transforms the content based on a difference between an aspect ratio of a first device 110a and an aspect ratio of the second device 110b.

Once the second collaboration application client 250b determines the one or more second coordinates and/or transforms the content, the second collaboration application client 250b displays the content on the second local application 240b. Thus, at this point, the content has been successfully transmitted from the first local application 240a on the first device 110a to the second local application 240b on the second device 110b.

The second collaboration application client 250b inserts and displays the content on the second local application 240b at a specific location represented by the one or more second coordinates. The look and feel of the content displayed on the second local application 240b match those of the content when originally displayed on the first local application 240a, thus providing a seamless content sharing experience between the first user 210a and the second user 210b. In particular, the content shared by the first user 210a is placed into the second local application 240b associated with the second user 210b at a desired location with a simple drag-and-drop action. Therefore, when the first user 210a shares a content with the second user 210b, the experience is similar to the simple process of moving a content from one window to another window on the same device.

The API implementing the one or more drag-and-drop actions described herein provides an error message to the first collaboration application client 250a if a drop action fails. For example, the first user 210a drags an image from a local slideshow presentation application (first local application 240a) and intends to drop the image into an audio streaming application (second local application 240b) of the second device 110b displayed via screen sharing in the collaboration session 200. However, the audio streaming application does not accept images via drag-and-drop actions. In this scenario, the drop action fails, and the first collaboration application client 250a receives an error message indicating the drop is invalid. Each local application can maintain a list of application-specific content that it accepts through drag-and-drop actions. After the first collaboration application client 250a receives the error message, the first collaboration application client 250a displays the error message to the first user 210a through the user interface.

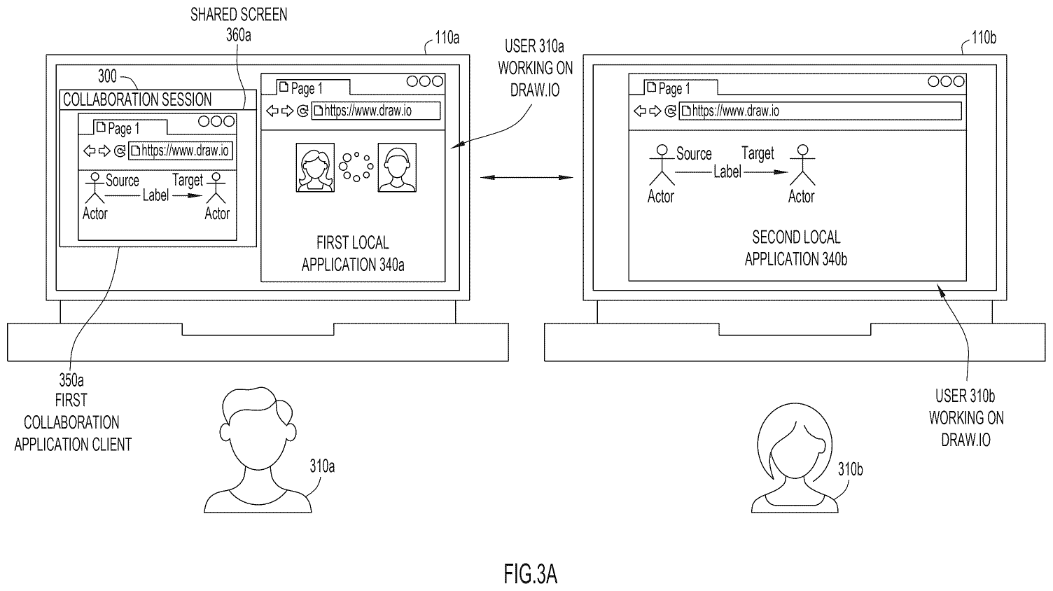

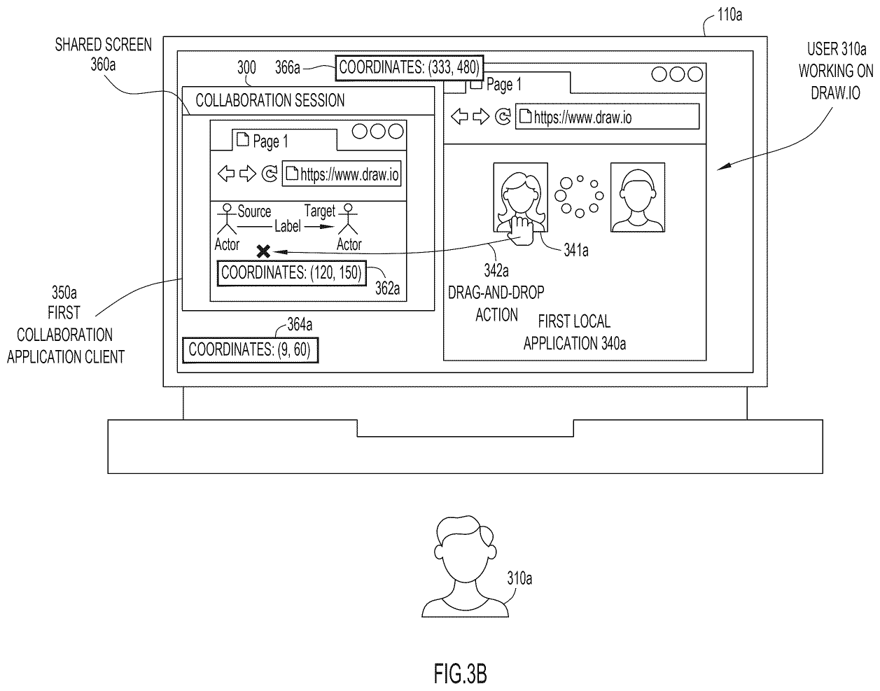

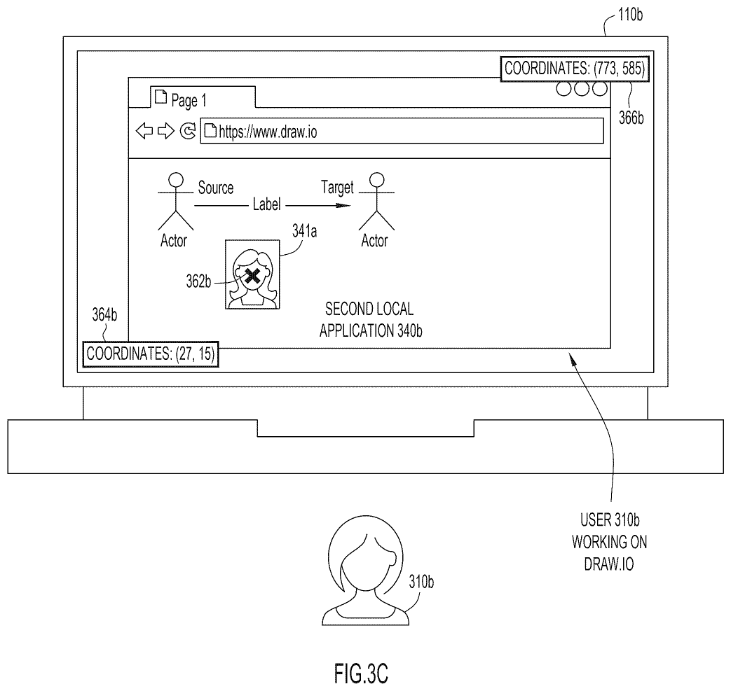

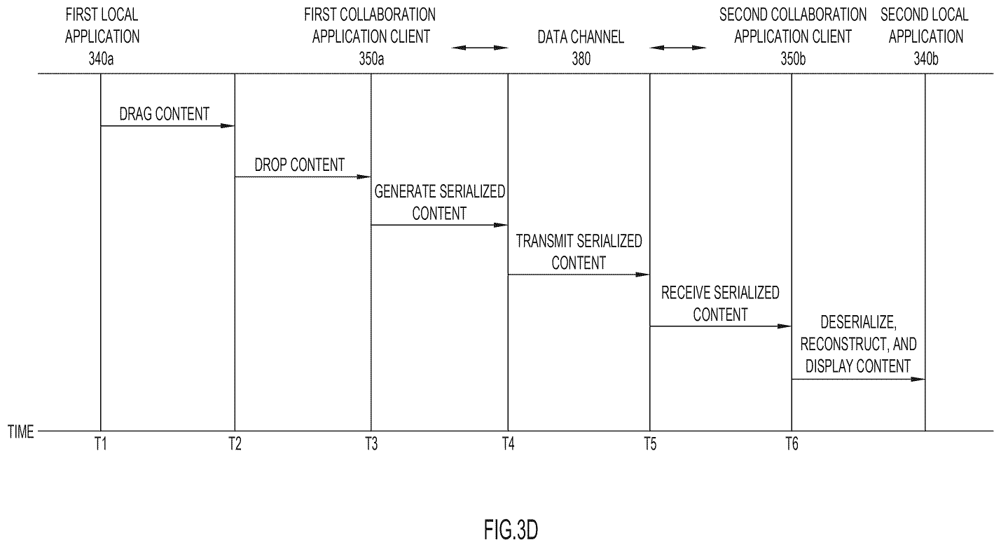

Reference is now made to FIG. 3A. FIG. 3A is a diagram illustrating a collaboration session 300 in which a second user 310b shares a second local application 340b with a first user 310a. The collaboration session 300 is established between a first collaboration application client 350a of a first device 110a and a second collaboration application client of a second device 110b.

The first user 310a of the first device 110a is working on a first local application 340a called “Page 1” and the second user 310b of the second device 110b is also working on the second local application 340b called “Page 1.” The “Page 1” application is a web application accessible via a uniformed resource locator (e.g., “https://www.draw.io”). By way of example, the “Page 1” application enables users to create, edit, or manipulate content such as image, icon, text, etc. In certain embodiments, the first local application 340a and the second local application 340b can be different types of applications.

In accordance with aspects of the techniques described herein, the second user 310b shares a screen showing the second local application 340b with the first user 310a using a screen-sharing functionality of the collaboration session 300, which renders the first collaboration application client of the first device 110a to display a shared screen 360a to the first user 310a. Thus, the first user 310a is able to view actions performed on the second local application 340b by the second user 310b.

Reference is now made to FIG. 3B. FIG. 3B is a diagram illustrating a drag-and-drop action 342a performed by the first user 310a. With continued reference to FIG. 3A, the first user 310a and the second user 310b are participating in the collaboration session 300 wherein the first collaboration application client 350a is displaying the shared screen 360a to the first user 310a. The shared screen 360a is of the second local application 340b on the second device 110b of the second user 310b.

In the collaboration session 300, the first user 310a shares a content 341a from the first local application 340a with the second user 310b by using the drag-and-drop action 342a to indicate a specific location in the second local application 340b where the first user 310a wishes to see the content 341a appear. In the drag-and-drop action 342a, the first user 310a drags a content 341a (e.g., an image or icon) from the first local application 340a and drops the content 341a in a drop location on the shared screen 360a displaying the second local application 340b. The drop location is represented by one or more first coordinates 362a, which include an x coordinate and a y coordinate on a screen of the first device 110a.

In the collaboration session 300, a location of the second local application 340b being displayed on the screen of the first device 110a is represented by coordinates 364a and coordinates 366a of the screen of the first device 110a. Based on the one or more first coordinates 362a, the coordinates 364a and the coordinates 366a, the first collaboration application client 350a determines one or more drop point coordinates relativity values. The one or more drop point coordinates relativity values are used to translate the one or more first coordinates 362a to one or more coordinates on a screen of the second device 110b where the content 341a will be displayed on the second local application 340b.

For example, the first user 310a drops the dragged content 341a at coordinates (120,150) located on the screen of the first device 110a. Thus, the one or more first coordinates 362a are (120, 150). The second local application 340b being displayed on the screen of the first device 110a is represented by coordinates 364a (9, 60) and coordinates 366a (333, 480). The one or more drop point coordinates relativity values, which represent a relationship between the drop location and a location in the shared second local application 340b, includes a drop point coordinates relativity value for x coordinate and a drop point coordinates relativity value for y coordinate.

The drop point coordinates relativity value for x-coordinate is calculated as follows: (x coordinate of coordinates 366a−x coordinate of coordinates 364a)/(x coordinate of one or more first coordinates 362a−x coordinate of coordinates 364a). Using exemplary coordinates from the example above, the drop point coordinates relativity value for x coordinate is (333−9)/(120−9)=2.9 (i.e., a ratio of 29:10).

The drop point coordinates relativity value for y-coordinate is calculated as follows: (y coordinate of coordinates 366a−y coordinate of coordinates 364a)/(y coordinate of one or more first coordinates 362a−y coordinate of coordinates 364a). Using exemplary coordinates from the example above, the drop point coordinates relativity value for y coordinate is (480−60)/(150−60)=4.6 (i.e., a ratio of 23:5).

After determining the one or more drop point coordinates relativity values, the first collaboration application client 350a generates a serialized data structure representing the content 341a in accordance with aspects of the techniques described herein. For example, the serialized data structure includes the following data and/or metadata:
Dragdropcontent {
content: <blob>,
sourceApp: Draw.io,
DropPointCoordinatesRelativity=[2.9,4.6],
Resolution: 800×600
. . .
}

Further, the size of the content 341a (e.g., an image or icon) can be adjusted based on a relative window size of the first device 110a and a relative window size of the second device 110b. Once the first collaboration application client 350a generates the serialized data structure representing the content 341a and receives permission to drop the content 341a from the second collaboration application client, the first collaboration application client 350a transmits a message and the serialized data structure to the second collaboration application client through a data channel between the first collaboration application client 350a and the second collaboration application client, in accordance with aspects of the techniques described herein.

Reference is now made to FIG. 3C. FIG. 3C is a diagram illustrating a drop of the content 341a in a specific location on the second local application 340b. With continued reference to FIGS. 3A and 3B, the second collaboration application client of the second device 110b receives a serialized data structure representing the content 341a from the first collaboration application client 350a. The second collaboration application client deserializes the serialized data structure to reconstruct an original data structure representing the content 341a, in accordance with aspects of the techniques presented herein. Thus, the second collaboration application client obtains the one or more drop point coordinates relativity values from the deserialized (reconstructed) data structure.

The second collaboration application client determines coordinates 364b and coordinates 366b, which represent a location of the second local application 340b on the screen of the second device 110b. For example, the location of the second local application 340b is represented by the coordinates 364b (27, 15) and the coordinates 366b (773, 585). The second collaboration application client determines one or more second coordinates 362b on the screen of the second device 110b where the content 341a received from first collaboration application client 350a will be displayed. The one or more second coordinates 362b is determined based on the coordinates 364b, the coordinates 366b, and the one or more drop point coordinates relativity values from the deserialized (reconstructed) data structure.

The one or more second coordinates 362b include an x coordinate and a y coordinate. The x coordinate of the one or more second coordinates 362b is calculated as follows: ((x coordinate of coordinates 366b−x coordinate of coordinates 364b)/drop point coordinates relativity value for x-coordinate)+x coordinate of coordinates 364b. Using exemplary coordinates from the example above, the x coordinate of the one or more second coordinates 362b is ((773−27)/2.9)+27=284.

The y coordinate of the one or more second coordinates 362b is calculated as follows: ((y coordinate of coordinates 366b−y coordinate of coordinates 364b)/drop point coordinates relativity value for y-coordinate)+y coordinate of coordinates 364b. Using exemplary coordinates from the example above, the y coordinate of the one or more second coordinates 362b is ((585−15)/4.6)+15=138.

In the example above, the one or more second coordinates 362b are (284, 138). The second collaboration application client displays the content 341a on the second local application 340b at the location represented by the one or more second coordinates 362b. Thus, at this point, the content has been successfully transmitted from the first local application 340a on the first device 110a to the second local application 340b on the second device 110b.

Reference is now made to FIG. 3D. FIG. 3D is a sequence diagram depicting a process for sharing content in a collaboration session between a first local application 340a of a first device 110a and a second local application 340b of a second device 110b. At time T1, a first user drags a content from a first local application 340a. At time T2, the first user drops the content into a first collaboration application client 350a displaying a second local application 340b shared by a second user. Then, at time T3, the first collaboration application client 350a generates a serialized data structure representing the content. At time T4, the first collaboration application client 350a transmits, via a data channel 380, the serialized data structure to the second collaboration application client 350b. Then, at time T5, the second collaboration application client 350b receives the serialized data structure. At time T6, the second collaboration application client 350b deserializes the serialized data structure to generate a reconstructed data structure. Using data from the reconstructed data structure, the second collaboration application client 350b determines local coordinates associated with the second local application 340b, and displays the content at the local coordinates.

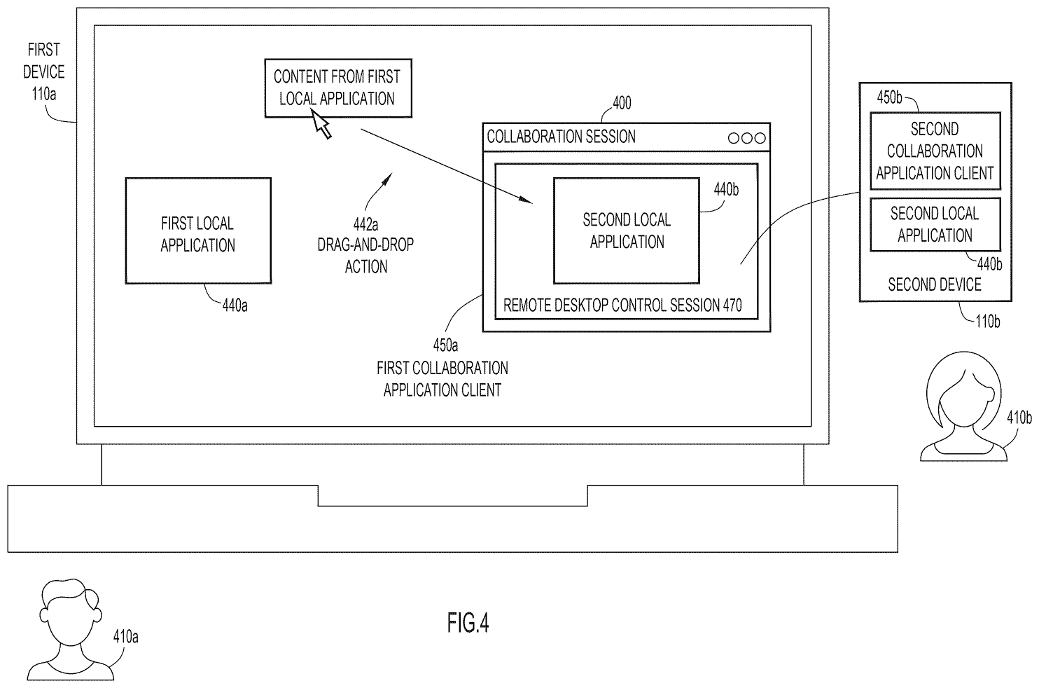

Turning now to FIG. 4, a diagram illustrating a remote desktop control session in which a first user drags a content from a first local application and drops the content into a second local application is described. In a collaboration session 400, a first user 410a of a first device 110a can access a screen of a second device 110b associated with a second user 410b through a remote desktop control functionality. In operation, the first user 410a requests access to the second device 110b using a control on a first collaboration application client 450a (e.g., through clicking a button). Upon receiving access permission from the second user 410b, a remote desktop control session 470 is initiated. During the remote desktop control session 470, the first user 410a takes control of input devices, such as keyboard and mouse, associated with the second device 110b. Through the input devices, the first user 410a can navigate the second device 110b through the first collaboration application client 450a, which displays a screen of the second device 110b to the first user 410a.

During the remote desktop control session 470 wherein the first user 410a takes control of the second device 110b, the first collaboration application client 450a detects one or more drag-and-drop actions 442a-n from the first user 410a. The one or more drag-and-drop actions 442a-n comprise the first user 410a dragging a content from a first local application 440a of the first device 110a and dropping the content into the screen of the second device 110b displayed on the first collaboration application client 450a. Upon detecting a drag-and-drop action 442a, the first collaboration application client 450a enters into a drop mode. In the drop mode, an implicit request control is enabled, wherein the first user 410a navigates the screen of the second device 110b through controlling the mouse and/or keyboard connected to the second device 110b.

Continuing with the remote desktop control session 470, the first user 410a gains access to a second local application 440b on the second device 110b. The first collaboration application client 450a detects a click from the first user 410a on a particular location on the screen of the second device 110b, wherein the particular location indicates a cursor position of a drop location of the content. Then, the first collaboration application client 450a captures one or more coordinates representing the particular location using any suitable API configured to detect and register coordinates associated with a drag-and-drop action.

The first collaboration application client 450a, using end-to-end encryption, serializes the content and the one or more coordinates representing the particular location to generate a serialized data structure. Then, the first collaboration application client 450a sends the serialized data structure to a second collaboration application client 450b associated with the second user 410b. Transmitting the one or more coordinates, along with the content, involves a light-weight message exchange between the first collaboration application client 450a and the second collaboration application client 450b. Thus, a drag-and-drop action in the remote desktop control session 470, as described herein, provides a secure and efficient way to share content.

Upon receiving the serialized data structure from the first collaboration application client 450a, the second collaboration application client 450b deserializes the serialized data structure to generate a reconstructed data structure comprising the content and the one or more coordinates. The second collaboration application client 450b determines one or more local coordinates based on the one or more coordinates. Then, the second collaboration application client 450b writes the content in the reconstructed data structure to the second local application 440b. The content is then displayed at the one or more local coordinates on the second local application 440b. Thus, the first user 410a, by taking remote control of the second device 110b, simply clicks on the screen of the second device 110b and drops the content to the location of the click. As such, the techniques described herein provide a simple and intuitive way to facilitate content sharing.

The API implementing the one or more drag-and-drop actions 442a-n provides an error message to the first collaboration application client 450a if a drop action fails. For example, the first user 410a drags an image from a local slideshow presentation application (first local application 440a) and intends to drop the image into an audio streaming application (second local application 440b) of the second device 110b displayed in the remote desktop control session. However, the audio streaming application does not accept images via drag-and-drop actions. In this scenario, the drop action fails, and the first collaboration application client 450a receives an error message through the API. Each local application can maintain a list of application-specific content that it accepts through drag-and-drop actions. After the first collaboration application client 450a receives the error message, it can display the error message to the first user 410a through a user interface. The first local application 440a and the second local application 440b can be a same or different type of applications.

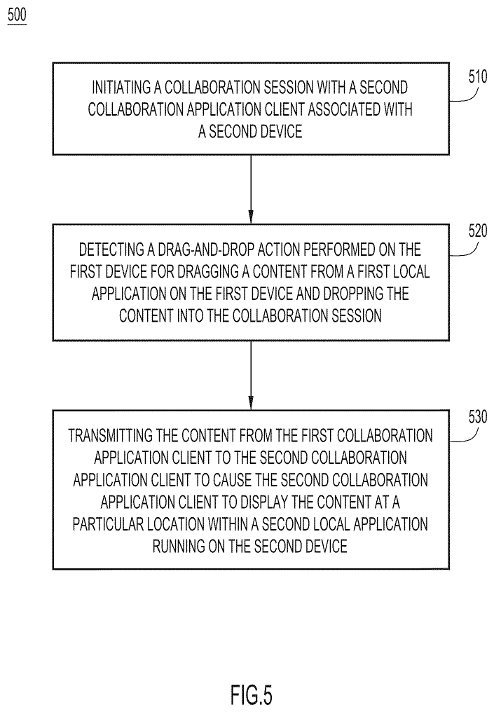

Reference is now made to FIG. 5, which is a flow diagram illustrating a method 500 for transmitting a content from a first collaboration application client to a second collaboration application client to cause the second collaboration application client to display the content at a particular location within a second local application running on the second device, according to an example embodiment.
At 510, the method 500 involves a first collaboration application client associated with a first device initiating a collaboration session with a second collaboration application client associated with a second device.
At 520, the method 500 involves the first collaboration application client detecting a drag-and-drop action performed on the first device for dragging a content from a first local application on the first device and dropping the content into the collaboration session.
At 530, the method 500 involves the first collaboration application client transmitting the content from the first collaboration application client to the second collaboration application client to cause the second collaboration application client to display the content at a particular location within a second local application running on the second device.

According to one or more example embodiments, the operation 530 of transmitting the content from the first collaboration application client to the second collaboration application client includes transmitting the content into the second local application that is being shared and displayed in the collaboration session.

In the method 500, the first local application and the second local application may be a same or different type of application.

According to one or more example embodiments, the operation 520 of detecting a drag-and-drop action includes determining one or more first coordinates representing a cursor position of a drop location associated with the drag-and-drop action and generating a serialized data structure representing the content.

In one form, the serialized data structure is configured to store one or more of: a content type, a local application identity, the one or more first coordinates, information associated with a device operating system, a window resolution, an aspect ratio, or a data object.

According to one or more example embodiments, the operation 530 of transmitting the content from the first collaboration application client to the second collaboration application client includes transmitting the serialized data structure to the second collaboration application client using end-to-end encryption, wherein the second collaboration application client is configured to reconstruct the serialized data structure.

In one form, the particular location within the second local application is represented by one or more second coordinates, and the one or more second coordinates are determined based on the one or more first coordinates and a window resolution of the first local application.

In one form, the one or more second coordinates are further determined based on a difference between a first window size of the first collaboration application client running on the first device and a second window size of the second collaboration application client running on the second device.

In one instance, the second local application in the method 500 is a slideshow presentation application, and the particular location is within a specific slide of one or more slides of a presentation.

In another instance, the second local application in the method 500 is a code editor application, and the particular location is within a code segment displayed by the code editor application.

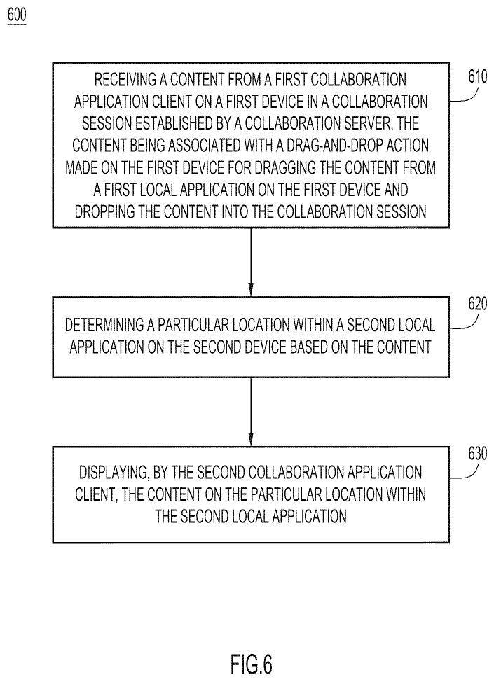

Reference is now made to FIG. 6, which is a flow diagram illustrating a method 600 for displaying a content on a particular location within a second local application.
At 610, the method 600 involves a second collaboration application client on a second device receiving a content from a first collaboration application client on a first device in a collaboration session established by a collaboration server, the content being associated with a drag-and-drop action made on the first device for dragging the content from a first local application on the first device and dropping the content into the collaboration session.
At 620, the method 600 involves the second collaboration application client determining a particular location within a second local application on the second device based on the content.
At 630, the method 600 involves the second collaboration application client displaying the content on the particular location within the second local application.

In the method 600, the content is represented by a serialized data structure configured to store one or more of: a content type, a local application identity, one or more first coordinates, information associated with a device operating system, a window resolution, an aspect ratio, or a data object.

According to one or more example embodiments, the operation 620 of determining a particular location within a second local application includes deserializing the serialized data structure to generate a reconstructed data structure and determining one or more second coordinates representing the particular location based on the reconstructed data structure.

In one form, the determining the one or more second coordinates includes determining a difference between a first window size of the first collaboration application client running on the first device and a second window size of the second collaboration application client running on the second device.

In one form, the one or more first coordinates represent a cursor position of a drop location associated with the drag-and-drop action.

In the method 600, the content is shared and displayed in the collaboration session prior to the second collaboration application client receiving the content from the first collaboration application client.

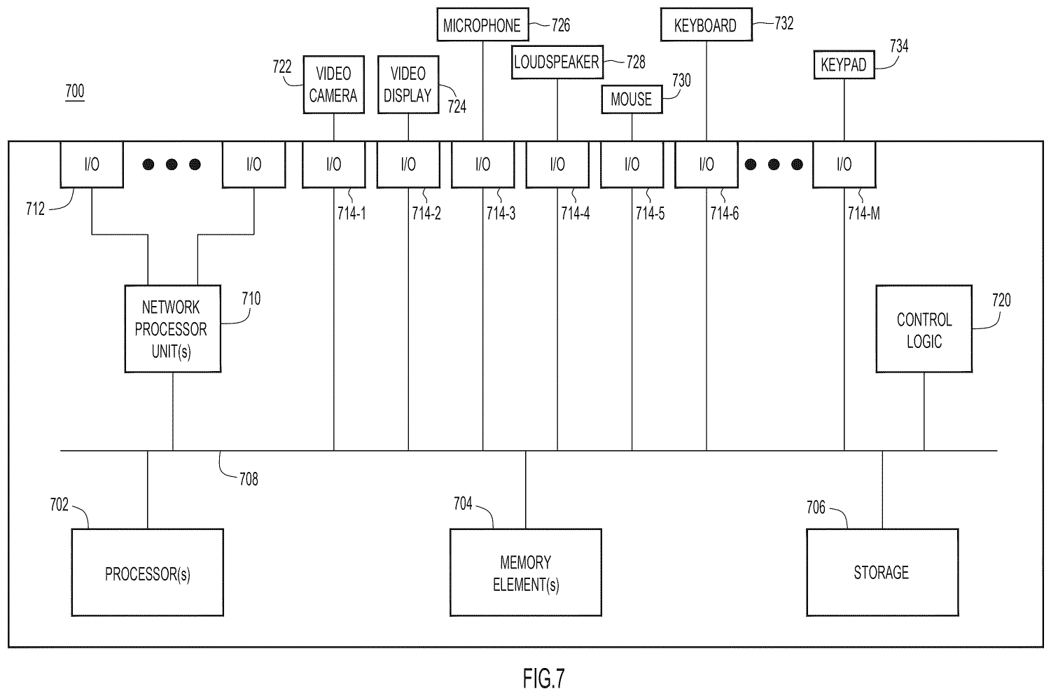

Referring to FIG. 7, FIG. 7 illustrates a hardware block diagram of a computing device 700 that may perform functions associated with operations discussed herein in connection with the techniques depicted in FIGS. 1, 2A, 2B, 2C, 3A, 3B, 3C, 3D and 4-6. In various embodiments, a computing device or apparatus, such as computing device 700 or any combination of computing devices 700, may be configured as any entity/entities as discussed for the techniques depicted in connection with FIGS. 1, 2A, 2B, 2C, 3A, 3B, 3C, 3D and 4-6 in order to perform operations of the various techniques discussed herein.

In at least one embodiment, the computing device 700 may be any apparatus that may include one or more processor(s) 702, one or more memory element(s) 704, storage 706, a bus 708, one or more network processor unit(s) 710 interconnected with one or more network input/output (I/O) interface(s) 712, one or more I/O interface(s) 714-1, 714-2, 714-3, 714-4, 714-5, 714-6, . . . , 714-M, and control logic 720. In various embodiments, instructions associated with logic for computing device 700 can overlap in any manner and are not limited to the specific allocation of instructions and/or operations described herein.

In at least one embodiment, processor(s) 702 is/are at least one hardware processor configured to execute various tasks, operations and/or functions for computing device 700 as described herein according to software and/or instructions configured for computing device 700. Processor(s) 702 (e.g., a hardware processor) can execute any type of instructions associated with data to achieve the operations detailed herein. In one example, processor(s) 702 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term ‘processor’.

In at least one embodiment, memory element(s) 704 and/or storage 706 is/are configured to store data, information, software, and/or instructions associated with computing device 700, and/or logic configured for memory element(s) 704 and/or storage 706. For example, any logic described herein (e.g., control logic 720) can, in various embodiments, be stored for computing device 700 using any combination of memory element(s) 704 and/or storage 706. Note that in some embodiments, storage 706 can be consolidated with memory element(s) 704 (or vice versa), or can overlap/exist in any other suitable manner.

In at least one embodiment, bus 708 can be configured as an interface that enables one or more elements of computing device 700 to communicate in order to exchange information and/or data. Bus 708 can be implemented with any architecture designed for passing control, data and/or information between processors, memory elements/storage, peripheral devices, and/or any other hardware and/or software components that may be configured for computing device 700. In at least one embodiment, bus 708 may be implemented as a fast kernel-hosted interconnect, potentially using shared memory between processes (e.g., logic), which can enable efficient communication paths between the processes.

In various embodiments, network processor unit(s) 710 may enable communication between computing device 700 and other systems, entities, etc., via network I/O interface(s) 712 (wired and/or wireless) to facilitate operations discussed for various embodiments described herein. In various embodiments, network processor unit(s) 710 can be configured as a combination of hardware and/or software, such as one or more Ethernet driver(s) and/or controller(s) or interface cards, Fibre Channel (e.g., optical) driver(s) and/or controller(s), wireless receivers/transmitters/transceivers, baseband processor(s)/modem(s), and/or other similar network interface driver(s) and/or controller(s) now known or hereafter developed to enable communications between computing device 700 and other systems, entities, etc. to facilitate operations for various embodiments described herein. In various embodiments, network I/O interface(s) 712 can be configured as one or more Ethernet port(s), Fibre Channel ports, any other I/O port(s), and/or antenna(s)/antenna array(s) now known or hereafter developed. Thus, the network processor unit(s) 710 and/or network I/O interface(s) 712 may include suitable interfaces for receiving, transmitting, and/or otherwise communicating data and/or information in a network environment.

I/O interface(s) 714-1 to 714-M allow for input and output of data and/or information with other entities that may be connected to computing device 700. For example, I/O interface(s) 714-1 to 714-M may provide a connection to external devices such as a video camera 722, video display (e.g., touch-screen display) 724, microphone 726, loudspeaker 728, mouse 730, keyboard 732, keypad 734, and/or any other suitable input and/or output device now known or hereafter developed. It is also envisioned that many of these external devices may be integrated as part of the computing device 700. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor, a display screen, or the like.

In various embodiments, control logic 720 can include instructions that, when executed, cause processor(s) 702 to perform operations, which can include, but not be limited to, providing overall control operations of computing device; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

The programs described herein (e.g., control logic 720) may be identified based upon application(s) for which they are implemented in a specific embodiment. However, it should be appreciated that any particular program nomenclature herein is used merely for convenience; thus, embodiments herein should not be limited to use(s) solely described in any specific application(s) identified and/or implied by such nomenclature.

In various embodiments, any entity or apparatus as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element’. Data/information being tracked and/or sent to one or more entities as discussed herein could be provided in any database, table, register, list, cache, storage, and/or storage structure: all of which can be referenced at any suitable timeframe. Any such storage options may also be included within the broad term ‘memory element’ as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, digital signal processing (DSP) instructions, software [potentially inclusive of object code and source code], etc.) for execution by one or more processor(s), and/or other similar machine, etc. Generally, memory element(s) 704 and/or storage 706 can store data, software, code, instructions (e.g., processor instructions), logic, parameters, combinations thereof, and/or the like used for operations described herein. This includes memory element(s) 704 and/or storage 706 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

In some aspects, the techniques described herein relate to a method including: initiating, by a first collaboration application client associated with a first device, a collaboration session with a second collaboration application client associated with a second device; detecting, by the first collaboration application client, a drag-and-drop action performed on the first device for dragging a content from a first local application on the first device and dropping the content into the collaboration session; and transmitting, by the first collaboration application client, the content from the first collaboration application client to the second collaboration application client to cause the second collaboration application client to display the content at a particular location within a second local application running on the second device.

In some aspects, the techniques described herein relate to a method, wherein transmitting includes transmitting the content into the second local application that is being shared and displayed in the collaboration session.

In some aspects, the techniques described herein relate to a method, wherein the first local application and the second local application are of a same or different type of application.

In some aspects, the techniques described herein relate to a method, wherein detecting includes: determining one or more first coordinates representing a cursor position of a drop location associated with the drag-and-drop action; and generating a serialized data structure representing the content.

In some aspects, the techniques described herein relate to a method, wherein the serialized data structure is configured to store one or more of: a content type, a local application identity, the one or more first coordinates, information associated with a device operating system, a window resolution, an aspect ratio, one or more drop point coordinates relativity values, or a data object.

In some aspects, the techniques described herein relate to a method, wherein transmitting includes: transmitting the serialized data structure to the second collaboration application client using end-to-end encryption, wherein the second collaboration application client is configured to reconstruct the serialized data structure.

In some aspects, the techniques described herein relate to a method, wherein the particular location within the second local application is represented by one or more second coordinates, and wherein the one or more second coordinates are determined based on the one or more first coordinates and a window resolution of the first local application.

In some aspects, the techniques described herein relate to a method, wherein the one or more second coordinates are further determined based on a difference between a first window size of the first collaboration application client running on the first device and a second window size of the second collaboration application client running on the second device.

In some aspects, the techniques described herein relate to a method, wherein the second local application is a slideshow presentation application, and wherein the particular location is within a specific slide of one or more slides of a presentation.

In some aspects, the techniques described herein relate to a method, wherein the second local application is a code editor application, and wherein the particular location is within a code segment displayed by the code editor application.

In some aspects, the techniques described herein relate to a method including: receiving, by a second collaboration application client on a second device, a content from a first collaboration application client on a first device in a collaboration session established by a collaboration server, the content being associated with a drag-and-drop action made on the first device for dragging the content from a first local application on the first device and dropping the content into the collaboration session; determining, by the second collaboration application client, a particular location within a second local application on the second device based on the content; and displaying, by the second collaboration application client, the content on the particular location within the second local application.

In some aspects, the techniques described herein relate to a method, wherein the content is represented by a serialized data structure configured to store one or more of: a content type, a local application identity, one or more first coordinates, information associated with a device operating system, a window resolution, an aspect ratio, one or more drop point coordinates relativity values, or a data object.

In some aspects, the techniques described herein relate to a method, wherein determining further includes: deserializing the serialized data structure to generate a reconstructed data structure; and determining one or more second coordinates representing the particular location based on the reconstructed data structure.

In some aspects, the techniques described herein relate to a method, wherein determining the one or more second coordinates further includes: determining a difference between a first window size of the first collaboration application client running on the first device and a second window size of the second collaboration application client running on the second device; and determining the one or more second coordinates on the second local application based on the difference and the one or more first coordinates associated with the first local application.

In some aspects, the techniques described herein relate to a method, wherein the one or more first coordinates represents a cursor position of a drop location associated with the drag-and-drop action.

In some aspects, the techniques described herein relate to a method, wherein the content is shared and displayed in the collaboration session prior to the second collaboration application client receiving the content from the first collaboration application client.

In some aspects, the techniques described herein relate to an apparatus including: a network interface that enables network communications on behalf of a first device; a memory; and one or more processors coupled to the network interface and the memory, wherein the one or more processors are configured to execute instructions for a first collaboration application client and a first local application running on the first device, and to perform operations including: initiating a collaboration session with a second collaboration application client associated with a second device; detecting a drag-and-drop action performed on the first device for dragging a content from the first local application on the first device and dropping the content into the collaboration session; and transmitting the content from the first collaboration application client to the second collaboration application client to cause the second collaboration application client to display the content at a particular location within a second local application running on the second device.

In some aspects, the techniques described herein relate to an apparatus, wherein the one or more processors are configured to perform transmitting by transmitting the content into the second local application that is being shared and displayed in the collaboration session.

In some aspects, the techniques described herein relate to an apparatus, wherein the first local application and the second local application are of a same or different type of application.

In some aspects, the techniques described herein relate to an apparatus, wherein the one or more processors are configured to perform detecting by: determining one or more first coordinates representing a cursor position of a drop location associated with the drag-and-drop action; and generating a serialized data structure representing the content.

### Variations and Implementations

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any local area network (LAN), virtual LAN (VLAN), wide area network (WAN) (e.g., the Internet), software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 802.11 (e.g., Wi-Fi®/Wi-Fi6®), IEEE 802.16 (e.g., Worldwide Interoperability for Microwave Access (WiMAX)), Radio-Frequency Identification (RFID), Near Field Communication (NFC), Bluetooth™, mm.wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may directly or indirectly connected utilizing any algorithms, communication protocols, interfaces, etc. (proprietary and/or non-proprietary) that allow for the exchange of data and/or information.

In various example implementations, any entity or apparatus for various embodiments described herein can encompass network elements (which can include virtualized network elements, functions, etc.) such as, for example, network appliances, forwarders, routers, servers, switches, gateways, bridges, loadbalancers, firewalls, processors, modules, radio receivers/transmitters, or any other suitable device, component, element, or object operable to exchange information that facilitates or otherwise helps to facilitate various operations in a network environment as described for various embodiments herein. Note that with the examples provided herein, interaction may be described in terms of one, two, three, or four entities. However, this has been done for purposes of clarity, simplicity and example only. The examples provided should not limit the scope or inhibit the broad teachings of systems, networks, etc. described herein as potentially applied to a myriad of other architectures.

Communications in a network environment can be referred to herein as ‘messages’, ‘messaging’, ‘signaling’, ‘data’, ‘content’, ‘objects’, ‘requests’, ‘queries’, ‘responses’, ‘replies’, etc. which may be inclusive of packets. As referred to herein and in the claims, the term ‘packet’ may be used in a generic sense to include packets, frames, segments, datagrams, and/or any other generic units that may be used to transmit communications in a network environment. Generally, packet is a formatted unit of data that can contain control or routing information (e.g., source and destination address, source and destination port, etc.) and data, which is also sometimes referred to as a ‘payload’, ‘data payload’, and variations thereof. In some embodiments, control or routing information, management information, or the like can be included in packet fields, such as within header(s) and/or trailer(s) of packets. Internet Protocol (IP) addresses discussed herein and in the claims can include any IP version 4 (IPv4) and/or IP version 6 (IPv6) addresses.

To the extent that embodiments presented herein relate to the storage of data, the embodiments may employ any number of any conventional or other databases, data stores or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Each example embodiment disclosed herein has been included to present one or more different features. However, all disclosed example embodiments are designed to work together as part of a single larger system or method. This disclosure explicitly envisions compound embodiments that combine multiple previously-discussed features in different example embodiments into a single system or method.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of’ can be represented using the ‘(s)’nomenclature (e.g., one or more element(s)).

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

The above description is intended by way of example only. Although the techniques are illustrated and described herein as embodied in one or more specific examples, it is nevertheless not intended to be limited to the details shown, since various modifications and structural changes may be made within the scope and range of equivalents of the claims.

What is claimed is:

1. A method comprising:
initiating, by a first collaboration application client associated with a first device, a collaboration session with a second collaboration application client associated with a second device;
detecting, by the first collaboration application client, a drag-and-drop action performed on the first device for dragging a content from a first local application on the first device and dropping the content into the collaboration session; and
transmitting, by the first collaboration application client, the content from the first collaboration application client to the second collaboration application client to cause the second collaboration application client to display the content at a particular location within a second local application running on the second device.

2. The method of claim 1, wherein transmitting comprises transmitting the content into the second local application that is being shared and displayed in the collaboration session.

3. The method of claim 1, wherein the first local application and the second local application are of a same or different type of application.

4. The method of claim 1, wherein detecting comprises:
determining one or more first coordinates representing a cursor position of a drop location associated with the drag-and-drop action; and
generating a serialized data structure representing the content.

5. The method of claim 4, wherein the serialized data structure is configured to store one or more of: a content type, a local application identity, the one or more first coordinates, information associated with a device operating system, a window resolution, an aspect ratio, one or more drop point coordinates relativity values, or a data object.

6. The method of claim 4, wherein transmitting comprises:
transmitting the serialized data structure to the second collaboration application client using end-to-end encryption, wherein the second collaboration application client is configured to reconstruct the serialized data structure.

7. The method of claim 4, wherein the particular location within the second local application is represented by one or more second coordinates, and wherein the one or more second coordinates are determined based on the one or more first coordinates and a window resolution of the first local application.

8. The method of claim 7, wherein the one or more second coordinates are further determined based on a difference between a first window size of the first collaboration application client running on the first device and a second window size of the second collaboration application client running on the second device.

9. The method of claim 1, wherein the second local application is a slideshow presentation application, and wherein the particular location is within a specific slide of one or more slides of a presentation.

10. The method of claim 1, wherein the second local application is a code editor application, and wherein the particular location is within a code segment displayed by the code editor application.

11. A method comprising:
receiving, by a second collaboration application client on a second device, a content from a first collaboration application client on a first device in a collaboration session established by a collaboration server, the content being associated with a drag-and-drop action made on the first device for dragging the content from a first local application on the first device and dropping the content into the collaboration session;
determining, by the second collaboration application client, a particular location within a second local application on the second device based on the content; and
displaying, by the second collaboration application client, the content on the particular location within the second local application.

12. The method of claim 11, wherein the content is represented by a serialized data structure configured to store one or more of: a content type, a local application identity, one or more first coordinates, information associated with a device operating system, a window resolution, an aspect ratio, one or more drop point coordinates relativity values, or a data object.

13. The method of claim 12, wherein determining further comprises:
deserializing the serialized data structure to generate a reconstructed data structure; and
determining one or more second coordinates representing the particular location based on the reconstructed data structure.

14. The method of claim 13, wherein determining the one or more second coordinates further comprises:
determining a difference between a first window size of the first collaboration application client running on the first device and a second window size of the second collaboration application client running on the second device; and
determining the one or more second coordinates on the second local application based on the difference and the one or more first coordinates associated with the first local application.

15. The method of claim 14, wherein the one or more first coordinates represents a cursor position of a drop location associated with the drag-and-drop action.

16. The method of claim 11, wherein the content is shared and displayed in the collaboration session prior to the second collaboration application client receiving the content from the first collaboration application client.

17. An apparatus comprising:
a network interface that enables network communications on behalf of a first device;
a memory; and
one or more processors coupled to the network interface and the memory, wherein the one or more processors are configured to execute instructions for a first collaboration application client and a first local application running on the first device, and to perform operations including:
initiating a collaboration session with a second collaboration application client associated with a second device;
detecting a drag-and-drop action performed on the first device for dragging a content from the first local application on the first device and dropping the content into the collaboration session; and
transmitting the content from the first collaboration application client to the second collaboration application client to cause the second collaboration application client to display the content at a particular location within a second local application running on the second device.

18. The apparatus of claim 17, wherein the one or more processors are configured to perform transmitting by transmitting the content into the second local application that is being shared and displayed in the collaboration session.

19. The apparatus of claim 17, wherein the first local application and the second local application are of a same or different type of application.

20. The apparatus of claim 17, wherein the one or more processors are configured to perform detecting by:
determining one or more first coordinates representing a cursor position of a drop location associated with the drag-and-drop action; and
generating a serialized data structure representing the content.
